(19) United States
(12) Patent Application Publication
(10) Pub. No.: US 2008/0066001 A1
(43) Pub. Date: Mar. 13, 2008

(54) Conferencing system with linked chat

(76) Inventors: Kenneth D. Majors, Lake Oswego, OR (US); Scott Deboy, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/900,828

(22) Filed: Sep. 12, 2007

Related U.S. Application Data
(60) Provisional application No. 60/844,498, filed on Sep. 13, 2006.

(51) Int. Cl. G06F 3/01

(52) U.S. Cl. 715/758

(57) ABSTRACT

A conferencing system includes plurality of users each of which is interconnected with a conferencing server. The users each can simultaneously view the same video stream provided by the conferencing server. The users may simultaneously textually communicating among themselves while viewing the video stream to create a textual communication. The conferencing server associating at least two portions of the textual communication and the video stream with one another.

### CROSS-REFERENCE TO RELATED APPLICATIONS

This application claims the benefit of U.S. Provisional App. No. 60/844,498, filed Sep. 13, 2006.

### BACKGROUND OF THE INVENTION

The present invention relates to a conferencing system and, more particularly, to a computer-based conferencing system enabling association between chat and video.

Many business activities are performed by teams of individuals that may be widely dispersed geographically. For example, product design and manufacturing are commonly performed by teams having members who are often located in facilities spread around the globe and/or who may be in transit between locations. If a decision is to be made concerning the project it may be necessary to quickly gather input and consensus from the members of the team regardless of their physical remoteness. Modern communication technology enables individuals to communicate over long distances and from remote locations. Conferencing systems facilitate communication between a plurality of remotely located users or conferees by allowing multiple users to communicatively interconnect with each other either directly as peers or by interconnecting with a central server that is interconnected to the other participants in the conference. Computer-based conferencing systems commonly provide for audio and video input from each of the conferees. In addition, a conferencing system may provide file sharing enabling conferees to view and edit files, including engineering drawings and spreadsheets that are part of the team's project.

One goal of a conferencing system is to connect a plurality of remotely located conferees and enable communication between the conferees as if the conferees were sitting at the same conference table. However, as the number of conference locations, sources of video, audio or other data input to the conference, increases, the ability of a group to communicate effectively in a conference decreases. For example, a separate transport stream, commonly comprising audio, video and textual data streams, is required for each conference location.

In addition, in a face-to-face conference, the conferees can assimilate a number of sensory inputs from fellow conferees and can selectively focus attention on one or more of the inputs. Typically a conference attendee takes notes during the conference on a tablet or a computer, which are reviewed later.

What is desired, therefore, is a conferencing system that enables the members of a group of participants in a conference and to effectively discuss the presentation.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a conferencing system.

FIG. 2 illustrates a chat sequence.

FIG. 3 illustrates correlation of the chat sequence and a video sequence.

FIG. 4 illustrates correlation of the chat sequence and a video sequence.

### DETAILED DESCRIPTION OF PREFERRED EMBODIMENT

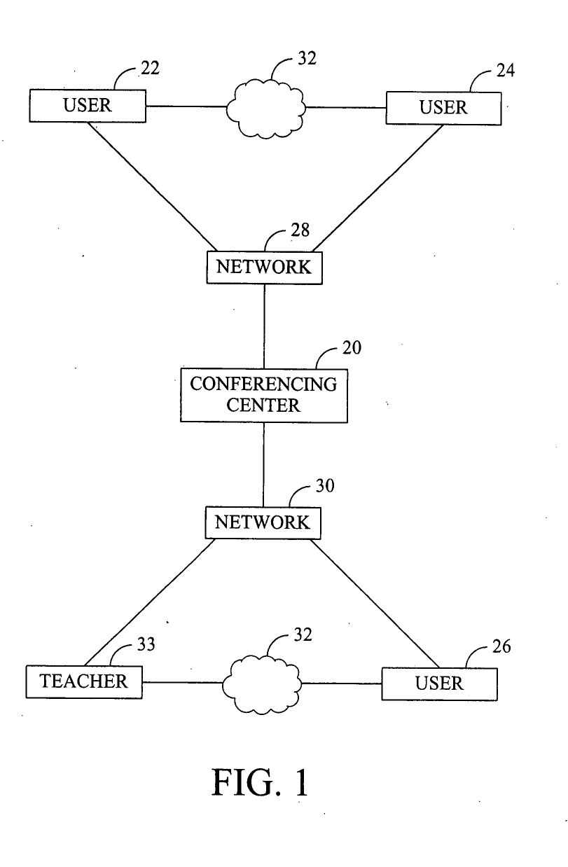

Referring to FIG. 1, a conferencing system 10 typically includes a conferencing server 20. The conferencing server 20 facilitates the interaction between a plurality of users 22, 24, 26. Each of the users typically uses a computer, a video monitor, a microphone, a speaker, a keyboard, a mouse, among other electronic devices. The users 22, 24, 26 are interconnected with the conferencing server through networks 28, 30. The networks 28, 30 may be any type of networks, such as for example, the Internet, wireless network, cellular network, local area network, and wide area network. The users 22 and 24 may likewise be interconnected among themselves, such as a network 32, which may be for example, the Internet, wireless network, cellular network, local area network, and wide area network. Also, the networks 28, 30, 32 may be a combination of different networking technologies. In some cases, the users communicate through the conferencing server 20 to send and receive audio and/or video feeds. Also, in some cases, the users communicate directly among themselves, such as in a peer-to-peer arrangement, to send and receive audio and/or video feeds. In addition, the users may communicate in a client-server manner with the conferencing server 20 (or another user) and/or a peer-to-peer manner among the users. Moreover, the users may share files and/or documents and/or share desktops in a similar manner.

During some conferencing sessions, such as during a class discussion, the teacher 33 may record the presentation in the form of audio and/or video. In this manner, the students may access the previously recorded audiovisual stream at a later time to review the presentation. Typically, the presentation is available through a network, such as the Internet, to all or a selected group of individuals. The presentation is typically stored at the conferencing server or any other suitable network accessible location.

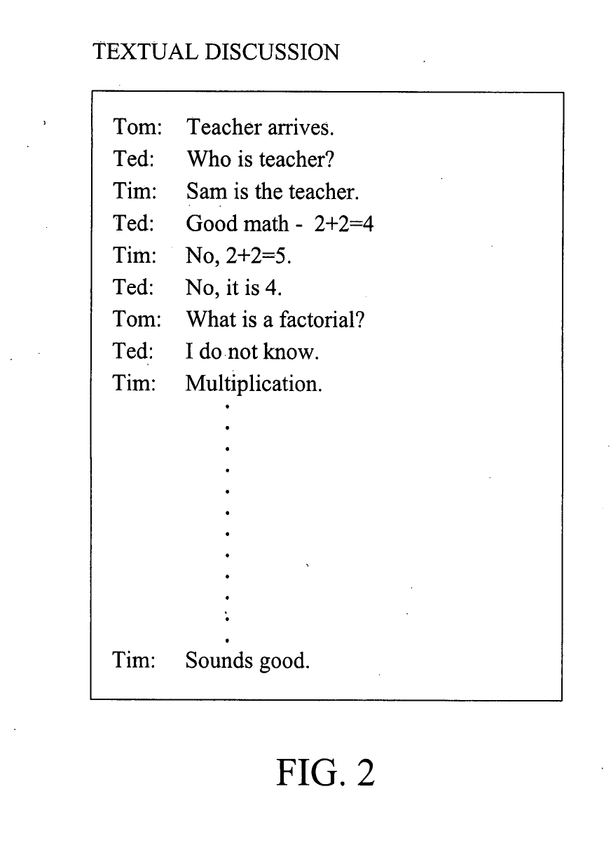

The conference attendees typically take notes on paper regarding the presentation. Accordingly, each of the attendees will have separate notes which they have taken. In many cases, some students may wish to share comments and use some type of chat interface to discuss the presentation among themselves. Referring to FIG. 2, the discussion among a plurality of different users regarding a particular audio visual presentation may be in the form of one or more textual discussions, such as a sequential chat. The discussions may likewise be extracted from e-mails, blogs, instant messaging, or other textual discussion mechanisms among the users. Different portions of the chat may be related to different portions of the video, since they tend to be generally contextual to different portions of the video.

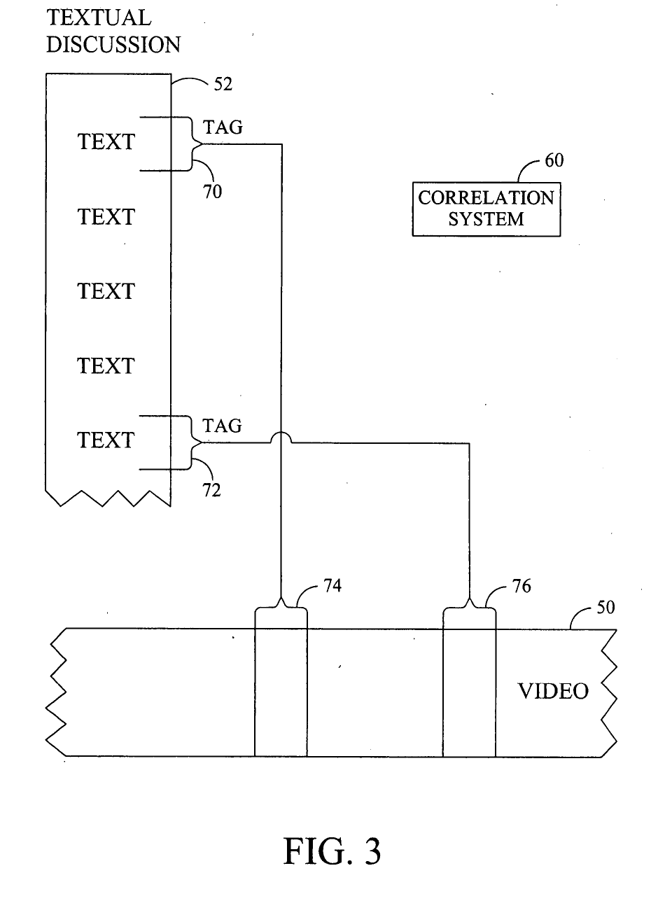

Referring to FIG. 3, an audio-video sequence 50 from a presentation is illustrated as a sequential set of frames. A textual discussion 52 is illustrated as a sequential discussion related, at least in part, to the audio-visual sequence 50. A correlation system 60 is incorporated in order for the same or other viewers of the discussion 52 and/or video 50 to correlate the related portions of the text with the video. The correlation system 60 may use tags 70, 72 or any other mechanism to identify portions of the textual discussion 52. The correlation system 60 may likewise use tags 74, 76 or any other mechanism to identify portions of the video 50. The tags 70, 72 for the textual discussion 52 may also be associated with a section of the textual discussion 52. The tags 74, 76 for the video 50 may be associated with a section (e.g., multiple frames) of the video 50.

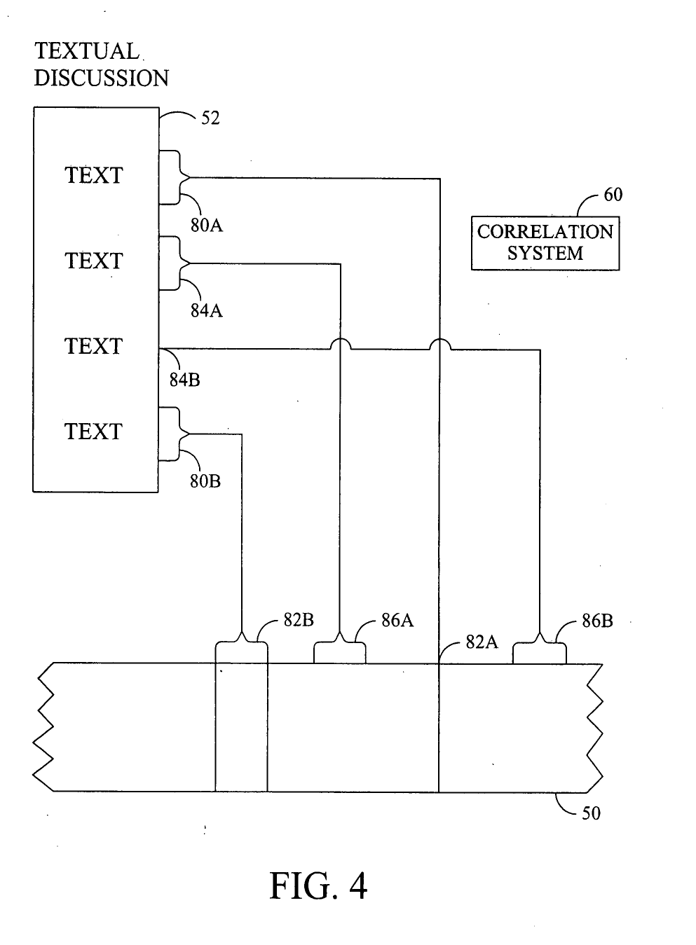

Referring to FIG. 4, the correlation system 60 may include one or more set of tags for a particular video sequence 50. For example tags 80A, 80B, for the textual discussion 52 may be associated with tags 82A, 82B of the video 50; while tags 84A, 84B, for the textual discussion 52 may be associated with tags 86A, 86B of the video 50. In this manner, each textual discussion 52 may include multiple tag sets which facilitates different portions of the video to be grouped together, such as based upon topic or otherwise related subject matter.

A correlation system may be included that associates particular tags for the chat with particular tags for the video. Also, selected tags of the textual discussion 52 may be associated with a plurality of different videos. Also, selected tags of the video 50 may be associated with a plurality of different textual discussions. In this manner, the viewer of the chat and/or video will be able to view relevant information from among multiple textual discussions 52 and multiple videos 50. Moreover, one video segment or start point in the video may be associated with another video segment or start point in another video. In addition, one textual discussion or start point in the textual discussion maybe associated with another textual discussion or start point in another textual discussion.

For example, while the viewer is reading through the chat, he may click on an icon associated with a tag to view the associated tagged video segment or play the video starting at the associated tag of the video. In this manner, the viewer is able to view the associated video segment or associated video from a predefined starting point to supplement the textual discussion.

For example, while the viewer is viewing the video, he may click on an icon associated with a tag to view the associated tagged textual discussion or start reading the textual discussion starting at the associated tag of the textual discussion. In this manner, the viewer is able to view the associated textual discussion or associated textual discussion from a predefined starting point to supplement the video sequence.

Depending on the particular configuration, the system may include tags for only the textual discussions and/or the video. Also, the correlations may be defined within a database structure so that the textual discussions and/or video do not include tags within their file structure. In this case, the presentation system for the video may signal the viewer of the existence of associated data within the textual discussions and provide access to the content. Also, the presentation system for the textual discussions may signal the viewer of the existence of associated data within the video and provide access to the content.

While the viewers are watching the video sequence they may engage in a chat among themselves in real-time. This provides a chat that is naturally sequenced in some manner with the video. The system may automatically correlate a frame or segment of the video with each portion of the chat that corresponds with what the viewers were likely viewing. This avoids the need for a user to manually associate portions of the video with the chat sequence. Also, the viewers may tag portions of their chat to correspond with the video. For example, the viewer may enter some text then press a ‘tag’ button to indicate that the associated portion of the video being viewed should be associated with this tag. This provides a natural way to determine the break points for the video sequence. The correlation system 60 may likewise use any suitable technique to determine a set of break points for the video sequence with associated textual portions. This provides convenient techniques for annotation of the video and chat sequence.

Each of the tags for the video and/or chat may be associated with a particular viewer, such as the viewer initiating the tag. Also, the tags may be individually named in a semantic manner to be indicative of the type of content to which it pertains. This results in a set of tags that are easier to understand the type of content to which they are associated with. Also, to simplify the tagging process the system may use an automatic naming convention for the tags. The viewer may, at a later time rename the tags, as desired.

In some cases, the portion of the text for different tagged portions of the chat will be of considerably different lengths. In many cases, the length of the tagged chat portion corresponds with the importance of that portion of the chat. In other cases, the length of the tagged video segment corresponds with the importance of that portion of the video. To indicate the importance of the chat portion or video segment, the size of the may be changed, such that larger segments/portions have a larger tag while smaller segments/portions have a smaller tag.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A conferencing system comprising:
(a) a plurality of users each of which is interconnected with a conferencing server;
(b) said plurality of users each of which can simultaneously view the same video stream provided by the conferencing server;
(c) said plurality of users simultaneously textually communicating among themselves while viewing said video stream to create a textual communication;
(d) said conferencing server associating at least two portions of said textual communication and said video stream with one another.

2. The conferencing system of claim 1 wherein said plurality of users each have a computer.

3. The conferencing system of claim 1 wherein said users are interconnected with said conferencing server though a network.

4. The conferencing system of claim 1 wherein said video stream further includes an audio stream.

5. The conferencing system of claim 1 wherein said textual communication is using a messaging system.

6. The conferencing system of claim 1 wherein said associating includes a frame of said video with a portion of said textual communication.

7. The conferencing system of claim 1 wherein said associating includes a segment of said video including a plurality of frames with a portion of said textual communication.

8. The conferencing system of claim 1 wherein said portion of said textual communication includes at least one line of said textual communication.

9. The conferencing system of claim 1 wherein said associating includes two separate sets of associations.

10. The conferencing system of claim 1 wherein one of said users may select a tag of said textual discussion to link to the associated part of said video.

11. The conferencing system of claim 1 wherein one of said users may select a tag of said video to link to the associated part of said textual discussion.
